(19) United States
(12) Patent Application Publication
(10) Pub. No.: US 2010/0109469 A1
(43) Pub. Date: May 6, 2010

(54) Capped stator core wedge and related method

(75) Inventors: Elena Rozier, Schenectady, NY (US); Waheed Tony Mall, Waterford, NY (US); Jeffrey D. Sheaffer, Glenville, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/289,574

(22) Filed: Oct. 30, 2008

(51) Int. Cl. H02K 3/487

(52) U.S. Cl. 310/214

(57) ABSTRACT

A slot wedge for a generator stator includes a wedge body having opposite side edges adapted to engage complimentary stator core slots. At least the opposite side edges are covered with an aramid paper or woven aramid fabric material.

The technology disclosed herein relates generally to rotary machines and, more specifically, to wedges used for the retention of conductor (or stator) bars in the stator core slots of dynamoelectric machines.

### BACKGROUND

Large dynamoelectric machines such as electrical generators employ a laminated stator core for transmitting induced voltages to the generator terminals through stator conductor bars. The cores are usually made by assembling already-slotted punchings or laminations in an annular housing for later enclosing the generator rotor. The slotted punchings, when assembled, define axially-extending, radially-oriented core slots which terminate at the radially inner-circumference of the stator annulus. The stator bars, or conductors, with ground insulation are laid in the radial slots and a wedging system is used to hold the bars in place against electromagnetic forces present when the machine is operating. If the wedging system is not effective, ground or conductor insulation may be damaged in the ensuing vibration, ultimately leading to a forced outage of the generator.

Electromagnetic fields in the generator induce forces on stators bars during normal operation or short circuit conditions that require wedges to support and restrain the bars within the stator core slots.

Currently fiberglass laminate material (such as, for example, National Electrical Manufacturers Association (NEMA) G11 is used in making the wedges, and while G11 provides good mechanical strength, it is abrasive to the stator laminations.

Cotton phenolic material has also been used as a wedge material, and while it is non-abrasive to the core, it has lower thermal and mechanical capability versus fiberglass laminates such as G11. The reduced mechanical strength and thermal capability of cotton phenolic thus limits the application of wedges made using this material. Other solutions such as low friction coatings have also been tried.

In U.S. Pat. No. 4,200,818, there is disclosed a stator wedge partially covered with a non-woven felt made of Kevlart, and in U.S. Pat. No. 4,607,183 there is disclosed a wedge with an abrasion resistant layer. In commonly owned, co-pending application Ser. No. 11/889,928, wedge bodies having surfaces in contact with the core are disclosed wherein at least the contact surfaces are covered with a woven aramid fabric material.

### BRIEF SUMMARY OF THE INVENTION

In one aspect, the present invention relates to a slot wedge for a stator adapted for use in a dynamoelectric machine comprising a wedge body having opposite side edges adapted to engage complimentary stator core slots, wherein at least the side edges are covered with an aramid paper material.

In another aspect, the invention relates to a slot wedge for a stator adapted for use in a dynamoelectric machine comprising a wedge body having opposite side edges adapted to engage complimentary stator core slots, the side edges each having a semi-circular shape, wherein at least the side edges are covered with a woven aramid fabric or an aramid paper material.

In still another aspect, the invention relates to a method of making a slot wedge for a stator adapted for use in a dynamoelectric machine comprising: (a) providing a fiberglass wedge body formed to a predetermined shape, including opposite side edges adapted for engagement within stator core slots; and (b) covering at least the opposite side edges of the wedge body with an aramid paper material.

Exemplary but nonlimiting embodiments of the invention will now be described in detail in connection with the drawings identified below.

### BRIEF DESCRIPTION OF THE DRAWINGS

FIG. 1 is a partial perspective view of a lower portion of a generator stator showing conventional dovetail wedges;

FIG. 2 is a perspective view of a pressure wedge in accordance with this invention;

FIG. 3 is a perspective view of another pressure wedge in accordance with the invention; and

FIG. 4 is an end elevation of still another wedge in accordance with the invention.

### DETAILED DESCRIPTION OF THE INVENTION

FIG. 1 of the drawings shows a lower portion of a dynamoelectric machine stator core 10. The dynamoelectric machine has a rotor (not shown) and a stator core, the latter being an annular structure which encloses (i.e., surrounds) the rotor when the rotor is assembled within the dynamoelectric machine. The stator core is assembled from a plurality of slotted punchings or laminations 12. The stator core 10 is formed with variable number of radially-oriented slots 14 spaced circumferentially around the inner annulus perimeter (only one shown), and which extend along the axial length of the stator core and terminate at their radially inner portions in, for example, a dovetail-shaped slot 16, as well understood in the art. The conductors 18 comprise insulated conductor strands including radially inner and outer bars 20 and 22, respectively. The conductors or conductor bars typically include electrical insulation 23 wrapped about the perimeter portions of conductor packages.

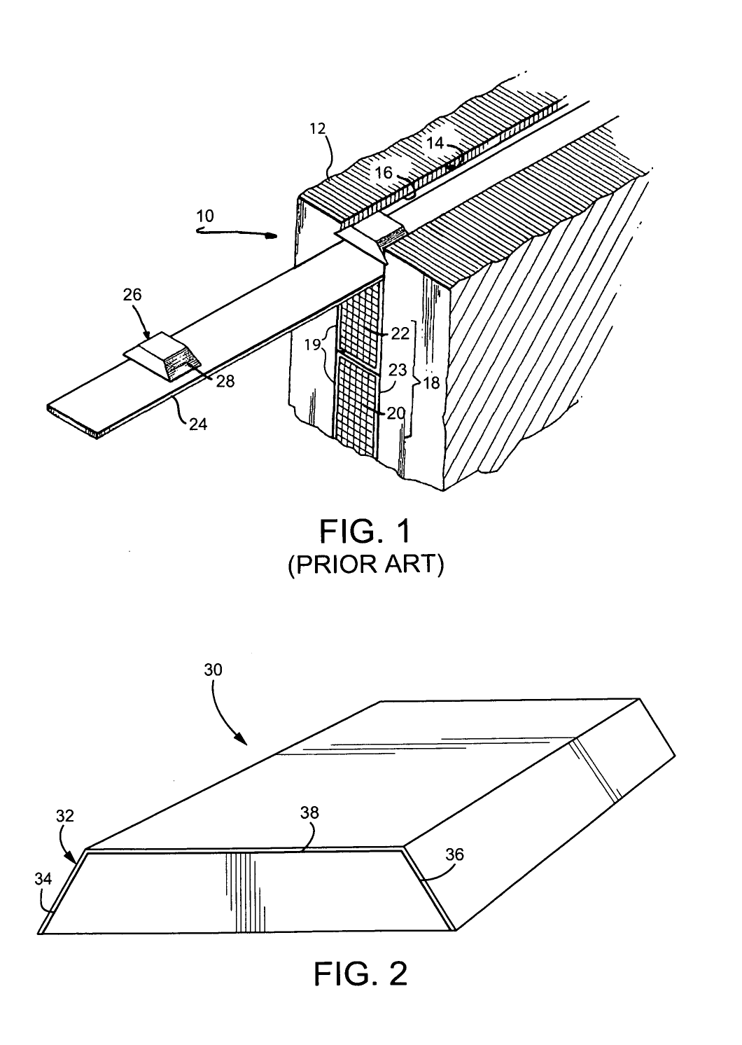

In conjunction with the foregoing, a filler strip 24 may extend axially (longitudinally) along the slot radially inward of bar 22. A number of dovetail wedges 26 are introduced into the slot 14 (and spaced apart along the axial length of the slot 14) so as to bear radially against the insulating filler strip 24. More typically, a ripple spring (not shown in FIG. 2) is interposed between the filler strip and the wedge. In other arrangements, the wedge (or wedges) is formed with an inclined bottom surface and a tapered slide is driven under the wedge to tighten it. In the latter arrangement, a top ripple spring may be located below the slide and on top of any one or more filler strips. As the slide is driven under the wedge, the ripple spring compresses to enhance the restraint of the stator bars in the core slots. It will be appreciated that the invention described herein is applicable regardless of wedge shape and regardless of whether slides, filler strips or ripple springs are employed.

The dovetail wedges are typically formed with oppositely-facing inclined surfaces 28 which engage inclined surfaces of the dovetail slot 16 to facilitate the assembly of the stator bar wedging system. The material used for the dovetail wedges 26 is preferably of high-strength insulating material which can be cut or molded to the desired wedge shape. The wedges are thus preferably formed of a molded resinous compound employing a suitable filler to add strength, or in the alternative, are formed of any suitable commercially-obtainable cotton phenolic materials such as Textolite® (a registered trademark of the General Electric Company). In some designs, however, and as noted above, cotton phenolic wedge by itself lacks the required mechanical strength for thinner and/or wider wedge configurations. It will be understood that the length of the wedges 26 may vary from what is shown in FIG. 1.

With reference to FIG. 2, and in accordance with a first exemplary, non-limiting implementation of the technology disclosed herein, a wedge 30 is constructed of, for example, fiberglass laminate G11 material which is partially or completely covered with at least one layer of an aramid paper material. The aramid paper prevents the fiberglass from directly contacting and helps reduce wear on the laminate punchings (i.e., the core slots). In addition, the aramid paper should provide adequate abrasion and tear resistance, and may also improve thermal capability, mechanical strength and dimensional stability. Preferably, the aramid paper covers at least the inclined side (or dovetail) edges or surfaces 34, 36, but as a practical manufacturing matter, the top surface 38 and or the bottom surface of the wedge may be covered.

One commercially available aramid paper well suited for use in this invention is available from E.I. du Pont de Nemours and Company, and sold under the trade name NOMEX®.

In a first exemplary process, the wedge itself is made from a prepeg fabric, a bulk molding compound, or a liquefied resin (e.g., G11) poured into a mold cavity containing a woven glass roll the length of the wedge 30. The aramid paper 32 may be applied to the wedge by molding, pultrusion, extrusion or by gluing the paper to the wedge. Molding, pultrusion and extrusion, where the surface applied integrally to the part (or wedge), producing the part in one step, are preferred over adhesive due to better bonding which prevents surface layer separation.

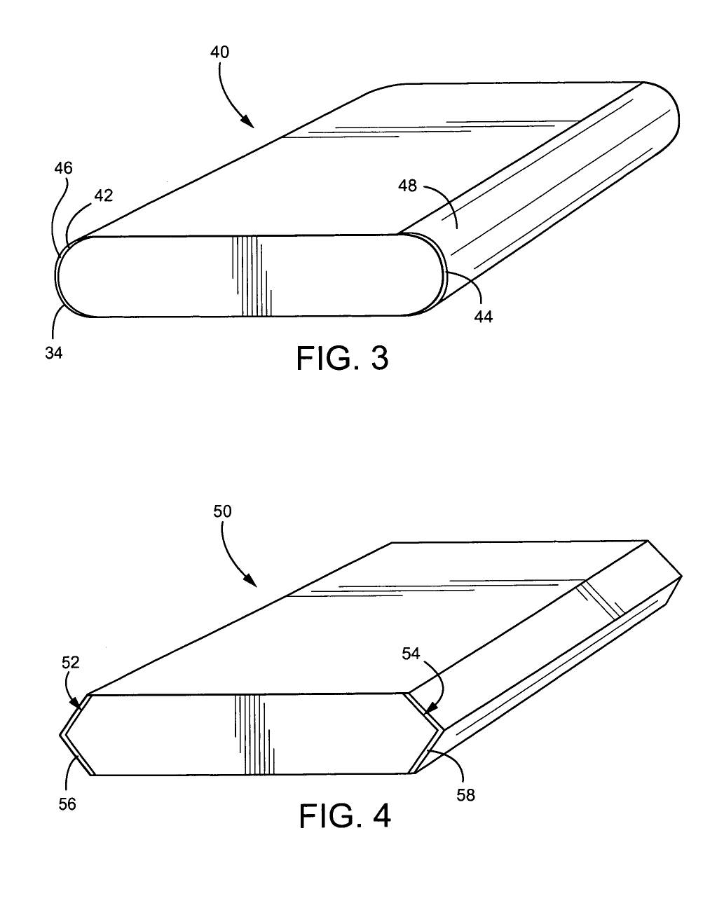

In another exemplary but nonlimiting embodiment illustrated in FIG. 3, the fiberglass wedge 40 is formed with semi-circular edges 42, 44 for use with core slots having complimentary shapes. Here again, the edges 42, 44 which engage the core slot may be covered with strips 46, 48 of an aramid paper (or a woven aramid fabric such as Kevlar®, Twaron® and Kernel®,) as described above. In addition, the top and/or bottom surfaces of the wedge may be covered as well. The materials and processes used in the manufacture of the wedge 40 and the application of the cover material may also be as described above.

With reference now to FIG. 4, still another exemplary wedge 50 is illustrated. Here, the edges 52, 54 of the wedge have an arrow-shape, again to match a corresponding core slot shape. As in the previously described embodiments, strips 56, 58 of aramid paper or aramid fabric may be applied along the side edges 52, 54, and, if desired, along the top and bottom surfaces as well.

It will be appreciated that the invention is equally applicable to wedges having other dimensional proportions (e.g., length to width ratios, thickness, etc.), and/or different edge shapes (e.g., oval, square, etc.) which engage the core slots, and thus the above-described embodiments are intended to be merely exemplary and nonlimiting. In addition, the core slot engaging surfaces may be continuous or intermittent along the length of the wedge bodies. For example, the dovetail surfaces could be notched at spaced locations along their respective lengths to enhance air flow and cooling.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A slot wedge for a stator adapted for use in a dynamoelectric machine comprising a wedge body having opposite side edges adapted to engage complimentary stator core slots, wherein at least said side edges are covered with an aramid paper material.

2. The slot wedge of claim 1 wherein a top surface extending between said side edges is also covered with said aramid paper material.

3. The slot wedge of claim 1 wherein said wedge body is substantially entirely covered with said aramid paper material.

4. The slot wedge of claim 1 wherein said wedge body is constructed of a fiberglass laminate.

5. The slot wedge of claim 1 wherein said aramid paper material is bonded to said wedge body.

6. The slot wedge of claim 1 wherein said aramid paper material is glued to said wedge body.

7. The slot wedge of claim 3 wherein said aramid paper material and said fiberglass laminate are bonded together by a process selected from a group comprising pultrusion, extrusion and molding.

8. The slot wedge of claim 1 wherein said side edges are dovetail-shaped.

9. The slot wedge of claim 1 wherein said side edges are semi-circular.

10. The slot wedge of claim 1 wherein said side edges are arrow-shaped.

11. A slot wedge for a stator adapted for use in a dynamoelectric machine comprising a wedge body having opposite side edges adapted to engage complimentary stator core slots, said side edges each having a semi-circular shape, wherein at least said side edges are covered with a woven aramid fabric or an aramid paper material.

12. The slot wedge of claim 11 wherein a top surface of said wedge body is also covered with said woven aramid fabric or aramid paper material.

13. A method of making a slot wedge for a stator adapted for use in a dynamoelectric machine comprising:
(a) providing a fiberglass wedge body formed to a predetermined shape, including opposite side edges adapted for engagement within stator core slots; and
(b) covering at least said opposite side edges of said wedge body with an aramid paper material.

14. The method of claim 13 wherein step (b) is carried out by pultrusion, extrusion, or molding.

15. The method of claim 13 wherein step (b) is carried out by gluing the aramid paper material to the wedge body.

16. The method of claim 13 wherein, during step (b), the entire wedge body is covered with said aramid paper material.

17. The method of claim 13 wherein said side edges have a dovetail shape.

18. The method of claim 13 wherein said opposite side edges have a semi-circular shape.

19. The method of claim 13 wherein said opposite side edges have an arrow-shape.
